(19) United States
(12) Patent Application Publication
(10) Pub. No.: US 2015/0016479 A1
(43) Pub. Date: Jan. 15, 2015

(54) LASER APPARATUS WITH BEAM TRANSLATION

(71) Applicant: Coherent Kaiserslautern GmbH, Kaiserslautern (DE)

(72) Inventor: Louis MCDONAGH, Kaiserslautern (DE)

(21) Appl. No.: 13/941,420

(22) Filed: Jul. 12, 2013

(51) Int. Cl. H01S 3/105

(52) U.S. Cl. CPC H01S 3/105
USPC 372/22; 372/70

(57) ABSTRACT

A laser-resonator is terminated between an outcoupling mirror and a semiconductor saturable absorbing mirror (SESAM). A beam-translator including two spaced-apart mirrors is located in the laser resonator in a beam-path of laser radiation circulating in the laser-resonator. The two spaced apart mirrors are selectively rotatable as a pair about two axes perpendicular to each other for selectively translating an incidence point of the laser radiation on the SESAM.

### TECHNICAL FIELD OF THE INVENTION

The present invention relates in general to laser apparatus including optical components with useful lifetime limited by optical damage. The invention relates in particular to means for extending the useful lifetime of such components.

### DISCUSSION OF BACKGROUND ART

There are optical components used in lasers that are susceptible to optical damage from laser-radiation produced by the lasers at useful working power. The most common such components are optically nonlinear crystals used to convert fundamental or second-harmonic radiation generated by a laser into ultraviolet (UV) radiation by sum-frequency mixing or frequency-doubling. Typically, the shorter the UV wavelength, the more susceptible is the nonlinear crystal to optical damage by that radiation. In a UV-generating laser, damage can also occur to other refractive components such as output windows.

Whatever the component, the optical damage appears at a spot where a UV radiation beam is incident on the component after some operation period less than would be considered a useful lifetime, or time between scheduled maintenance periods, of the laser. This damage period depends, inter alia, on one or more of the material of the component, the surface preparation of the component, the wavelength of the radiation, and the power in the beam.

An almost universally practiced method of prolonging the useful lifetime of such components is to periodically move the component with respect to the laser beam when optical damage begins (or would be expected) to noticeably affect the performance of the laser. In this manner, the useful life of a component can be extended, depending on the aperture of the component relative to the beam, to one-hundred or more times the “one-spot” damage period. Optically nonlinear crystals, which have tight alignment requirements for maintaining an optimum phase-matching are moved by precision translation stages. These translation stages are preferably capable of very small computer controlled incremental movements in two mutually perpendicular (x- and y-) axes perpendicular the beam-propagation (z-) axis.

Another laser component susceptible to optical damage is a semiconductor saturable-absorption mirror (SESAM) used as a resonator mirror to provide either passive Q-switching or mode-locked operation of a laser. Such a mirror is also frequently referred to as a saturable Bragg reflector (SBR). The designation SESAM is used throughout this document for consistency of description In this kind of mirror, damage is not limited to UV damage, and occurs at the fundamental wavelength of the laser. Movement of the mirror with respect to the resonating mode (beam) of the laser can also be used to extend the useful lifetime of the mirror.

As the mirror is a resonator mirror, alignment requirements are usually more critical than those for an optically nonlinear crystal. Even in a relatively misalignment-tolerant resonator, beam misalignment will change the pointing direction of the output beam of the resonator. This can adversely affect the performance of any apparatus supplied by the output beam. High-precision translation stages for such a mirror can add substantially to the cost of a laser. Where cooling of such a mirror may be required, as is sometimes the case for semiconductor saturable absorption mirrors (SESAMs) to achieve optimum and stable performance, such translation stages can also complicate cooling arrangements.

One means of translating a beam relative to an optically-nonlinear crystal without translating the crystal is described in U.S. Pre-Grant Publication No. 2005/0254532 and in U.S. Pre-Grant Publication No. 20110222565. In each of these systems, beam translation is effected by passing a beam through a thick parallel surface, refractive element arranged at an angle to the incident beam. The refractive elements are described as being bi-axially rotatable about the incident-beam direction for translating a transmitted beam in two lateral directions orthogonal to each other. Compensating elements are provided for restoring the translated beam on the original path after the beam has traversed the crystal. These of course must be correspondingly rotated. In the 2005 publication, a mechanism for providing the biaxial rotation of the refractive element is described, which, while probably effective for the intended purpose, is complicated. It is also probable that such elements would introduce astigmatism into an optical system including them.

However effective this refractive-element rotation method may be for the optically nonlinear crystal application, it would in most instances be unsuitable for use with a SESAM in a mode-locked-laser. This is because refractive index dispersion introduced in a resonator by such elements would usually adversely influence the shape or duration of the mode-locked output pulses.

### SUMMARY OF THE INVENTION

In one aspect of the present invention optical apparatus includes a laser-resonator terminated by first and second mirrors. A gain-element is located within the laser-resonator. A source of optical pump-radiation is arranged to deliver optical pump-radiation to the gain-element thereby causing a beam of laser-radiation to circulate in the laser-resonator between the first and second end-mirrors along a beam-path. The beam path is normally incident on the first and second mirrors at corresponding first and second incidence points. A plurality of beam-translation mirrors is located within the laser-resonator in beam-path, the beam-translation mirrors are spaced apart in a fixed relationship with each other, with the laser-radiation beam incident on each of the beam-translation mirrors an acute angle of incidence. The plurality of beam-translation mirrors is selectively rotatable as a group about at least a first axis. The laser-radiation beam makes an even number of reflections from the plurality of beam-translation mirrors. The selective rotation of the plurality of beam-translation mirrors selectively changes the incidence angle of the laser-radiation beam on each of the plurality of beam-translation mirrors thereby selectively translating the second incidence point on the second end-mirror, while maintaining normal incidence of the beam path on the second end-mirror.

In another aspect of the present invention, optical apparatus comprises an optically nonlinear crystal arranged to accept a beam of laser-radiation incident thereon along a beam-path. The beam of laser radiation has at least a first-wavelength radiation component. The optically nonlinear crystal converts the first-wavelength radiation component to radiation having a second wavelength different from the first wavelength. First and second mirrors are located in the beam-path. The first and second mirrors are spaced apart in a fixed relationship with each other with reflecting faces thereof facing each other. The laser radiation beam is incident on the first and second mirrors at respectively first and second acute angles of incidence. The first and second mirrors are selectively rotatable as a pair about at least a first axis. The selective rotation of the first and second mirrors selectively changes the incidence angles of the beam on the first and second mirrors thereby selectively translating the beam of laser-radiation incident on the optically nonlinear crystal.

In yet another aspect of the present invention optical apparatus comprises, an optical component arranged to accept a beam of laser-radiation. First and second mirrors are provided. The first and second mirrors are spaced apart in a fixed relationship parallel to each other with reflecting faces thereof facing each other. The laser-radiation beam incident on the first mirror along a first path at non-normal incidence thereto. The laser-radiation beam is reflected from the first mirror to the second mirror along a second path at an angle to the first path. The laser-radiation beam is reflected from the second mirror along a third path to a beam-spot on the optical component, the third path being parallel to the first path and laterally translated therefrom. The first and second mirrors are continuously rotatable as a pair about an axis coincident with the first path, such that the beam-spot on the optical component is continuously translated around the optical component on a circular path.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates one preferred embodiment of mode-locked laser-resonator in accordance with the present invention terminated at one end thereof by a semiconductor saturable absorbing mirror (SESAM) and one example of a beam-translator in accordance with the present invention including first and second mirrors spaced apart and parallel to each other and selectively rotatable as a pair for selectively translating a circulating laser-beam across the SESAM in one preferred direction while maintaining the beam at normal incidence to the SESAM and parallel to the un-translated input beam.

FIG. 1A schematically illustrates detail of the translating action of the beam translator of FIG. 1.

FIG. 1B schematically illustrates another preferred embodiment of mode-locked laser-resonator in accordance with the present invention similar to the embodiment of FIG. 1, but wherein the first and second mirrors are enlarged to permit two reflections from each mirror to provide the selective translation.

FIG. 1C schematically illustrates yet another preferred embodiment of mode-locked laser-resonator in accordance with the present invention similar to the embodiment of FIG. 1, but wherein the second mirror is enlarged and a third mirror is added to permit one reflection from each of the first and third mirrors and two reflections from the second mirror to provide the selective translation.

FIG. 2 is a three-dimensional view schematically illustrating details of a beam translator similar to the beam translator of FIG. 1A, but selectively rotatable about two axes perpendicular to each other for selectively translating a circulating laser-beam in two perpendicular directions while maintaining the original propagation direction of the translated beam.

FIG. 3 is a three-dimensional view schematically illustrating details of a beam translator similar to the beam translator of FIG. 2 used with an optically nonlinear crystal arranged for generating third-harmonic (3H) radiation from an input beam including fundamental radiation and second-harmonic (2H) radiation.

FIG. 3A is an elevation view schematically illustrating details of a beam-waist of the input beam in the optically nonlinear crystal of FIG. 3.

FIG. 4 schematically illustrates a beam translator similar to the beam translator FIG. 1 used to continually rotate a translated output beam about an axis defined by an input beam for rotating the translated beam on an optical element.

FIG. 4A schematically illustrates detail of rotation of the translated beam on the optical element of FIG. 4

FIG. 5A and FIG. 5B schematically illustrate beam translation by another example of a beam translator in accordance with the present invention similar to the beam translator of FIG. 1, but wherein the first and second mirrors are not parallel to each other, where translated beams are parallel to each other, but where the translated beams are not parallel to the un-translated (input) beam.

FIG. 6 is a graph schematically illustrating lateral translation and path length changes as a function of rotation (incidence) angle in an example of the beam translator of FIG. 1.

### DETAILED DESCRIPTION OF THE INVENTION

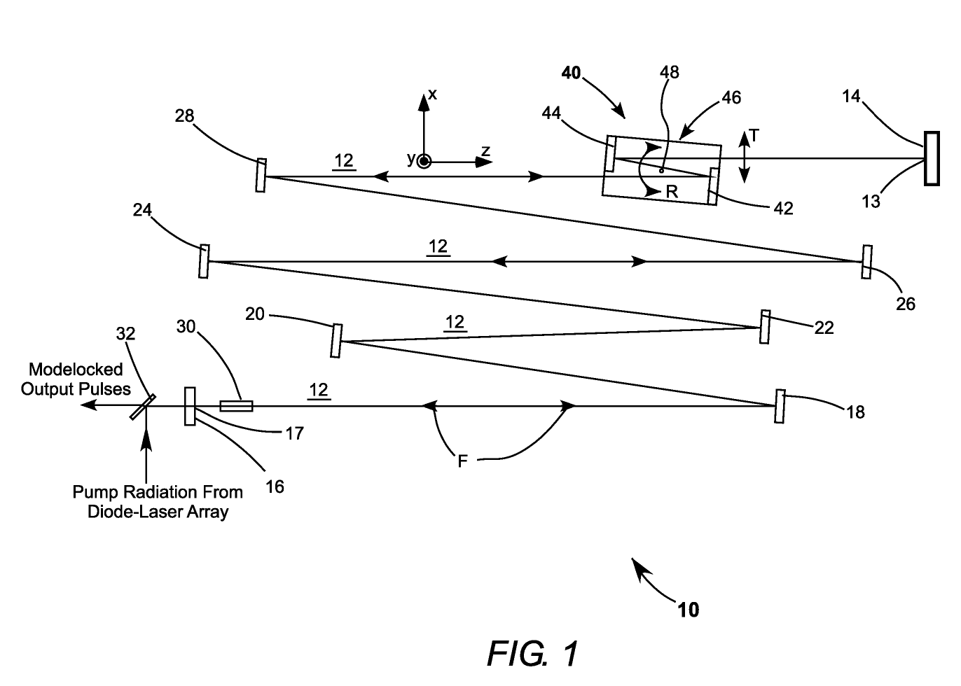

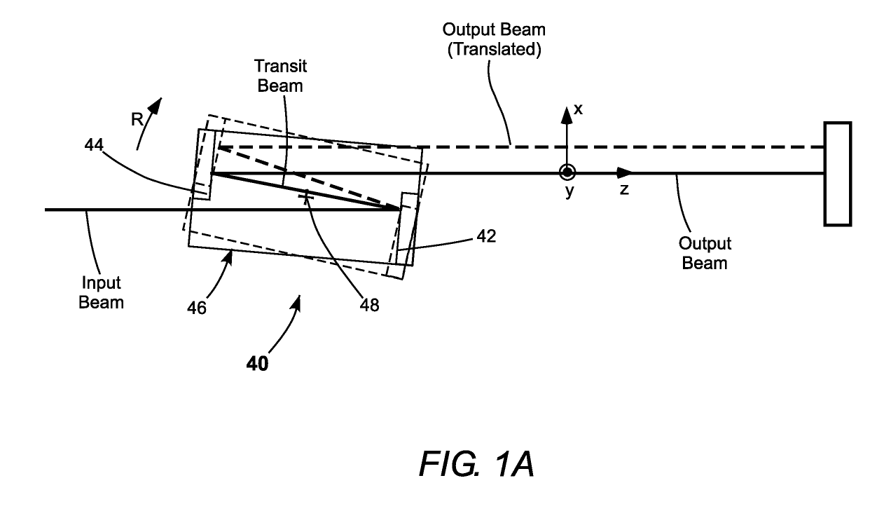

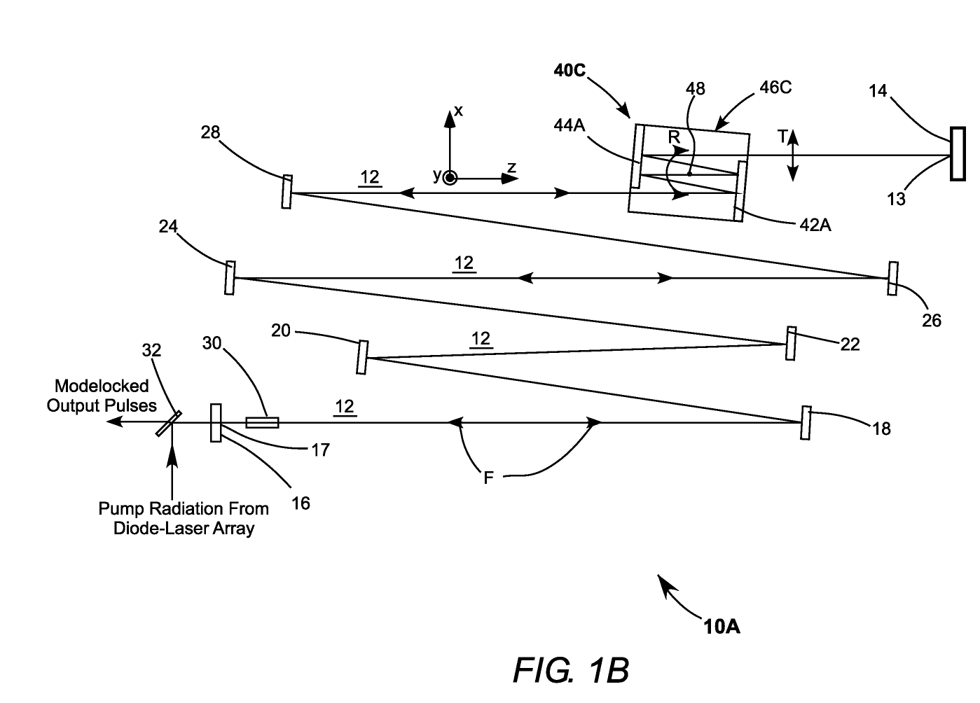

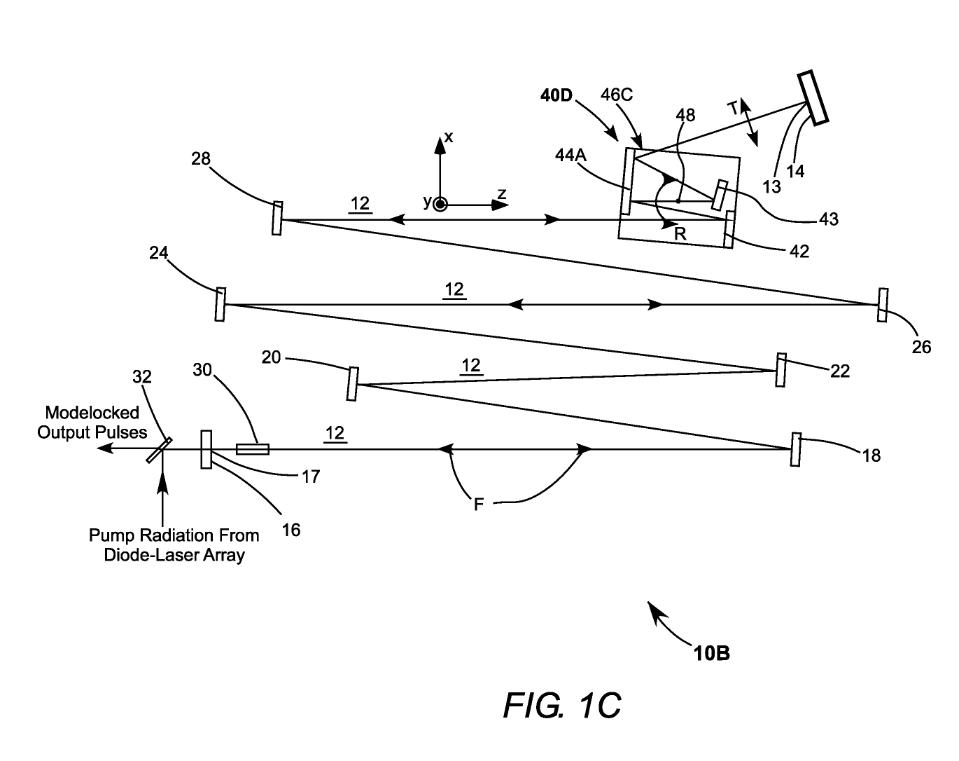

Referring now to the drawings, wherein like components are designated by like reference numerals, FIG. 1 schematically illustrates a preferred embodiment 10 of a mode-locked laser in accordance with the present invention. Laser 10 includes a laser-resonator 12 terminated by a maximally reflecting semiconductor saturable absorbing mirror (SESAM) 14 and a partially reflecting and partially transmitting out-coupling mirror 16. Resonator 12, here, is “folded” by mirrors 18, 20, 22, 24, 26 and 28, for minimizing the “footprint” of the laser consistent with providing a resonator having sufficient length to provide (cooperative with SESAM 14) reliable mode-locking at a desired pulse-repetition frequency (PRF) on the order of tens of megahertz (MHz). The provision of folding mirrors allows for dispersion compensation with the mirrors having a suitable dispersion profile. This provides for shorter output pulses delivered by the laser.

Typically, such as resonator can have a length between about 1 meter and about 20 meters. The pulse repetition period of mode-locked output pulses is determined by the round-trip time for radiation in the laser-resonator, and the mode-locked operation is induced by the SESAM, as is known on the art. Resonator 12 includes a solid-state gain-element 30, which is end-pumped by radiation from a diode-laser array not shown. The diode-laser-radiation is folded into the resonator by a dichroic mirror 32 maximally reflective for the diode-laser-radiation, and maximally transmissive for the laser-radiation. Circulation of fundamental radiation in the resonator is designated by arrows F.

The circulating radiation is incident at a fixed incidence point 17 on mirror 16, and an incidence point 13 on SESAM 14. Incidence point 13 can be selectively translated on SESAM 14, as described hereinbelow. This translation can be accomplished without changing fixed incidence point 16 or the (normal) angle incidence of the circulating radiation on mirror 16 and SESAM 14.

In FIG. 1, a set of Cartesian x-, y-, and z-axes is depicted for facilitating description of the present invention. The z-axis is parallel to the longitudinal axis and beam-propagation direction of the resonator. Those skilled in the art will recognize that the z-axis will be folded by the folding mirrors.

Continuing with reference to FIG. 1 and with reference in addition to FIG. 1A, laser 10 includes an inventive beam translation device (beam-translator) 40. Beam-translator 40 provides for periodically translating the circulating laser beam F across SESAM 14 for extending the useful lifetime of the SESAM, while keeping the beam normally incident on the (plane) mirror. In this embodiment, translator 40 includes a first mirror 42 and a second mirror 44, spaced apart and parallel to each other. Mirrors 42 and 44 are mounted on a stage 46 selectively rotatable about an axis 48 as indicated by arrows R. Axis 48 here is perpendicular to the x-z plane which is the beam-propagation plane.

Rotating stage 46 rotates the mirrors as a group. The selective rotation selectively translates the beam incident on the SESAM in the x-z plane as indicated by arrows T in FIG. 1. FIG. 1A depicts two positions of beam-translator 40 one in solid lines, the other in long-dashed lines. Corresponding beam-paths through the inventive beam- translator are depicted by solid and long-dashed lines respectively. For purposes of facilitating further detailed description of this and other embodiments of the inventive beam-translator set forth below, the following descriptive convention is adopted.

The beam propagating in the positive z-axis direction and incident on mirror 42 is referred to as the input beam. Mirror 42 is referred to as the first mirror or the input-mirror. The beam between mirrors 42 and 44 is referred to as the transit beam. Mirror 44 is referred to as the second mirror or the output mirror. The beam propagating from mirror 44 to the SESAM is referred to as the output beam.

Here, it should be noted that while rotation axis 48 is depicted as being about mid-way between the input and out mirrors the rotation-axis could be anywhere between the mirrors and even coincident with any one of the mirrors. The axis position only has an effect on beam translation on the mirrors. The axis does not even have to be between the mirrors. An axis between the mirrors is preferred, however, for minimizing beam translation on the mirror surfaces. By way of example, a rotation axis at the input mirror would provide that the input beam were incident at about the same point on the input mirror whatever the rotation angle. Mechanical design considerations for stage 46 may influence the choice or rotation-axis position.

FIG. 1B schematically illustrates another preferred embodiment 10A of mode-locked laser-resonator in accordance with the present invention similar to the embodiment of FIG. 1, but wherein beam-translator 40 is replaced by a beam-translator 40C. In beam-translator 40C, an enlarged stage 46A allows enlarged mirrors 42A and 44A to be substituted for mirrors 42 and 44 respectively. The enlarged mirrors are arranged to cause the beam-path through the beam-translator to make two reflections from mirror 42A and two reflections from mirror 44A. This arrangement can be useful, for example, if a more compact (shorter) beam-translator is desired.

FIG. 1C schematically illustrates yet another preferred embodiment 10B of mode-locked laser-resonator in accordance with the present invention similar to the embodiment of FIG. 1, but wherein beam-translator 40 is replaced by a beam-translator 40D. In beam-translator 40D, an enlarged stage 46A allows an enlarged mirrors 44A to be substituted for mirror 44, and a third mirror 43 to be added facing mirror 44A. Here the beam-path makes one reflection from mirror 42 one reflection from mirror 43 and two reflections from mirror from mirror 44A. In this arrangement, mirror 43 is not parallel to mirrors 42 and 44A such that the beam path emerging from the beam-translator is no longer parallel to the input beam, but still translates in the same (emergent) direction to maintain normal incidence on mirror 14. This kind of translation by non-parallel mirrors is described in detail further hereinbelow.

Those skilled in the art will recognize from the description provided above that the inventive beam-translator can have other combinations of mirrors, parallel or non-parallel, without departing from the spirit and scope of the present invention. What is necessary to achieve the parallel translation is that the total number of reflections from those mirrors must be an even number. In beam-translator 40, that even number is two. In beam-translators 40C and 40D, the even number is four.

A significant advantage of this inventive beam-translation is that there not any requirement for highly accurate, selectively translatable mount for SESAM 14. This provides that the SESAM mount can, relatively easily, be made more compatible with other requirements, such as cooling in particular. Bearings for stage 46 of beam-translator 40 do not need to be high-precision bearings, as angular variations in the bearing will not affect the incidence angle of the output beam on the SESAM. In this particular example of the inventive translator, with parallel input and output mirrors, there can be angular variations in the x-z and y-z planes, or rotations about the z-axis, without affecting the normal incidence of the output beam on the SESAM.

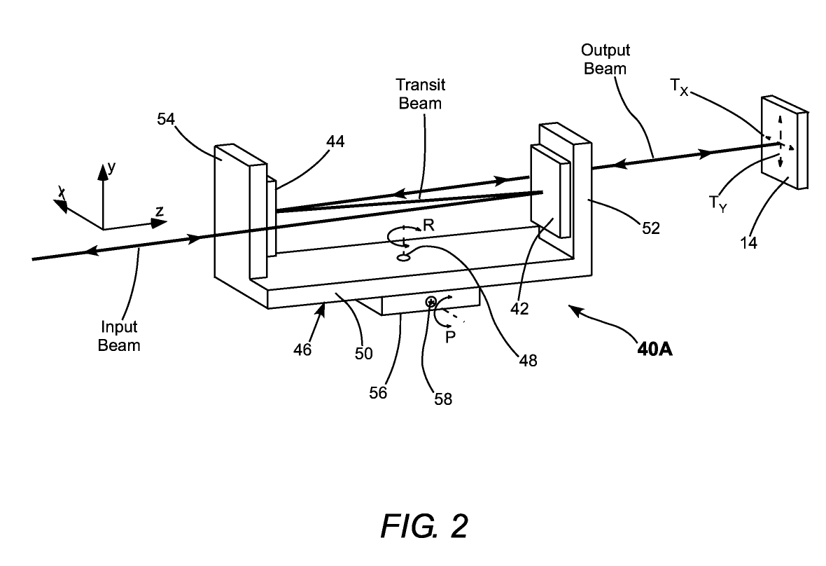

The requirement for beam translation on SESAM depends on the geometrical form of the SESAM. SESAMS are typically epitaxially grown on a semiconductor wafer which is later diced into a required (orthogonal) form. For a SESAM in the form of a rectangular strip, beam translation needs to be in one direction only as depicted in FIG. 1, and FIG. 1A. Typically between about 10 and about 40 selective beam translations would be required over the lifetime of the SESAM. For a square-shaped SESAM translation in two orthogonal directions (two dimensions) may be required to cover the entire area of the SESAM. A description of an arrangement for providing such a two-dimensional translation is set forth below with reference to FIG. 2.

Here, a beam translator 40A includes the above described stage 46 rotatable about axis 48. Mirrors 42 and 44 are supported on end-plates 52 and 54 respectively. A platform 56 is attached to stage 46, and is selectively rotatable about an axis 58, (parallel to the x-axis), as depicted by arrows P. Rotating about the y-axis as indicated by arrow R causes translation of the output beam in direction Tₓ on SESAM 14. Rotation about the x-axis, as indicated by arrow P, causes translation of the output beam in direction T_{y} on SESAM 14.

The two-dimensional translation described above with reference to FIG. 2 can also be used for translating a beam on an optically nonlinear crystal that is used for converting infrared (IR) or visible radiation to ultraviolet(UV) radiation by frequency multiplication or sum-frequency mixing. UV radiation at powers involved in such an application invariably causes damage at the exit face of such a crystal and beam-translation is required, as described in the background section above, to relocate the beam to undamaged parts of the face for extending the useful lifetime of the crystal. Typically, tens of beam translations are performed before a crystal ceases to be practically usable.

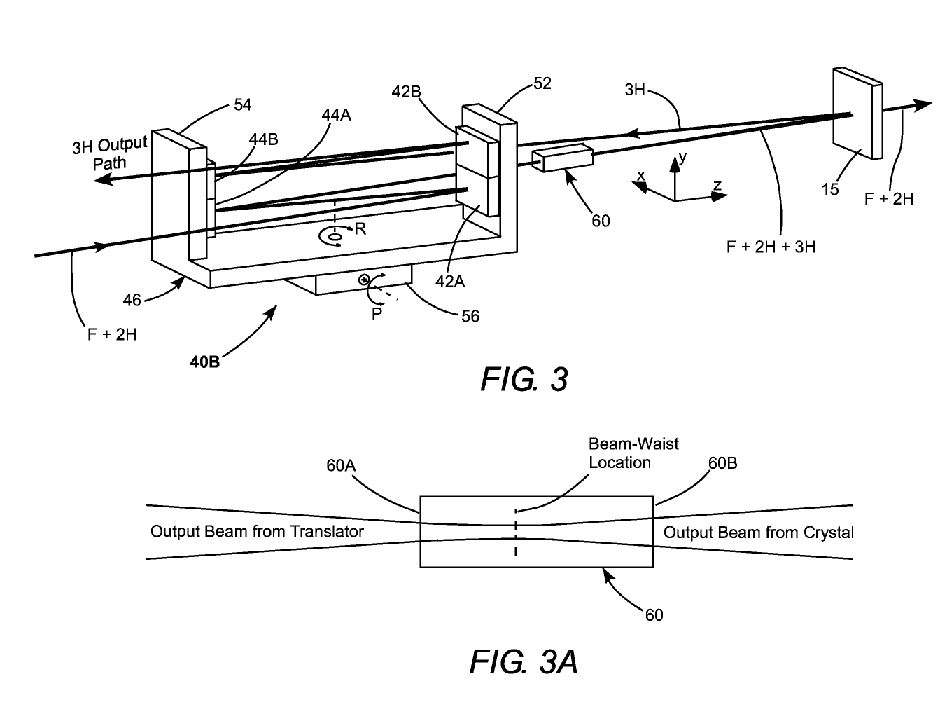

FIG. 3 schematically illustrates the inventive beam translator arranged to make such translations in an arrangement for converting fundamental (F) and second-harmonic (2H) radiation to third-harmonic 3H radiation in an optically nonlinear crystal 60. The beam-translator, here designated translator 40B, is similar to beam-translator 40A of FIG. 2 with an exception that input mirror 42 is replaced by a mirror 42A with another mirror 42B superposed. These can actually be separate units, or a single unit with separate coatings, with the lower coated to reflect fundamental and second harmonic radiation, for example 1064 nanometer (nm) radiation and 532 nm-radiation, and the upper coated to reflect 355 nm-radiation (3H-radiation). Also SESAM 14 of FIG. 2 is replaced in the arrangement of FIG. 3 by a dichroic filter 15 arranged to reflect the 3H radiation, and transmit fundamental and 2H-radiation.

Translation action for input and output beams is as described above. Radiation entering crystal 60 comprises the fundamental and second-harmonic radiation. The output beam on leaving the crystal comprises fundamental, 2H and 3H radiation. The 3H-radiation may propagate at an angle from the F and 2H beams depending on the geometry and phase-matching configuration of crystal 60. The 3H-radiation is reflected from filter 15 at a slight angle to the beam incident thereon. This can be due to the walk-off angle alone or some combination of the walk-off angle and a slight tilt, in one direction or another of filter 15. This allows precise control of the reflection direction. The crystal is oriented, and the filter tilted (if it is tilted) such that the 3H beam is directed back to mirror 44B and transits to mirror 42B, which reflects the 3H beam out of the translator. Accordingly, for any useful range of translations of the beam on crystal 60, the 3H radiation will always leave beam-translator 40B on the same path.

FIG. 3A depicts detail of the input beam in crystal 60. This is focused into the crystal to increase energy density of the beam in crystal for optimizing frequency-conversion. The focused beam is characterized by a beam-waist, usually selected to be in a particular longitudinal position within the crystal. In FIG. 3A the beam diameter is exaggerated compared with the crystal dimensions for convenience of illustration. By way of example a crystal may have entrance exit faces about 3 mm×3 mm and length of about 20 mm. The beam-waist diameter may be about 300 micrometers (μm).

Various arrangements (either inside or outside a resonator) for providing a beam-waist in an optically nonlinear crystal are well known in the art. A description of such arrangement is not necessary for understanding principles of the present invention and accordingly is not presented herein. The significance of the beam-waist position itself with respect to the invention is discussed further herein below.

Regarding providing incremental rotary motions R and P for the inventive translator, this can be accomplished by periodic manual adjustment or automatically using readily available stepper-motors operated by programmed circuitry to provide a particular pattern of translation. This pattern can be unique, or according to any particular algorithm described in the prior-art for crystal translation (crystal-shifting), without departing from the spirit and scope of the present invention.

It should be noted also that the beam-translator could also function with four total reflections from two or more mirrors as described above with reference to FIGS. 1B and 1C. Generally, however, translation distance will be so small that this will not be necessary.

Those skilled in the art to which the present invention pertains will recognize, without further detailed description or illustration, that the arrangement of FIG. 3 can be used for wavelength conversion other than sum-frequency conversion of fundamental and second-harmonic radiation to third-harmonic radiation. By way of example, the optically nonlinear crystal can be arranged to convert input radiation having only a fundamental-wavelength component to second-harmonic radiation. Mirror 15 in such an arrangement could be coated to reflect the 2H-radiation and transmit residual fundamental-wavelength radiation.

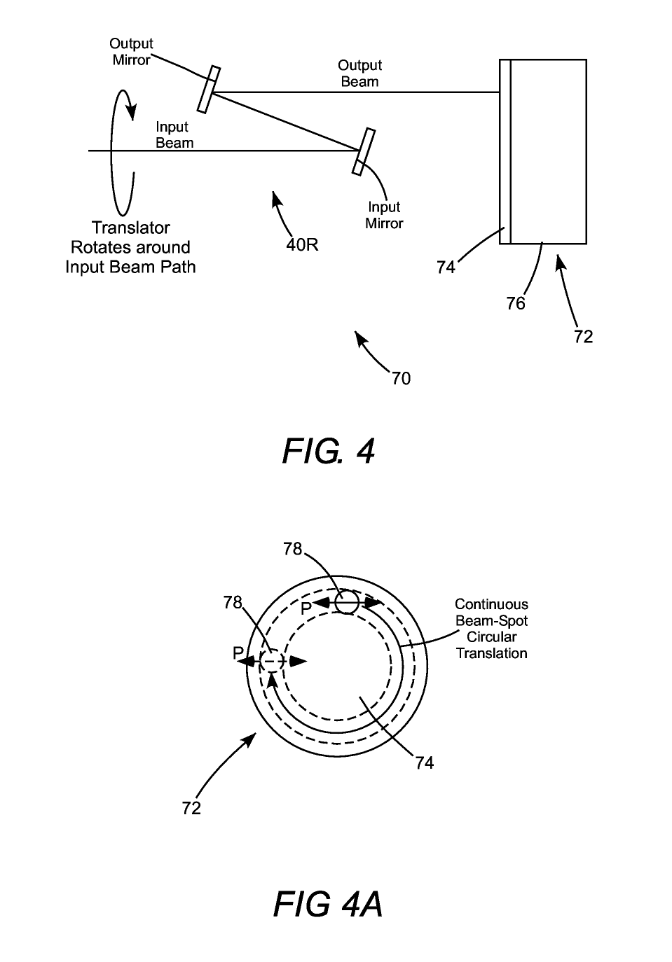

In addition to providing incremental beam translations as described above the present invention can provide rotary motion of a translated beam either using suitable drives for bi-axial rotation or in a simpler scheme depicted in FIG. 4 and FIG. 4B. Here an arrangement 70 includes a gain unit 72 including a thin-disk gain-medium 74 supported on a heat sink 76. A translator 40R provides that an input beam is directed toward the periphery of the gain medium as depicted in FIG. 4A.

The translator is rotated continuously about the input beam direction which causes the output beam of the translator, and an associated beam-spot to translate continuously over the gain-medium, as depicted in FIG. 4, around a circular path depicted by dashed lines, while keeping a constant orientation of the beam-spot, here characterized as a polarization-orientation depicted by arrows P. This provides an advantageous alternative to prior-art arrangements in which the gain-unit itself is rotated. This inventive rotation allows for fixed mounting of the gain unit which provides for consistent alignment and more alternatives for efficient cooling of the gain-medium. If the beam is rotated fast enough to spread the heat load on the path, temperature and thermal effects, including lensing, are significantly reduced compared to an arrangement in which the beam-spot is stationary on the gain medium. This allows for applying higher pump-powers and achieving higher output-power than could be achieved if the beam spot were fixed on the gain medium.

Here, again, it should be noted that be noted that the (fixed) beam-translation could be effected function with four total reflections from two or more mirrors as described above with reference to FIG. 1B. This could be used as discussed above to provide a more compact rotating device.

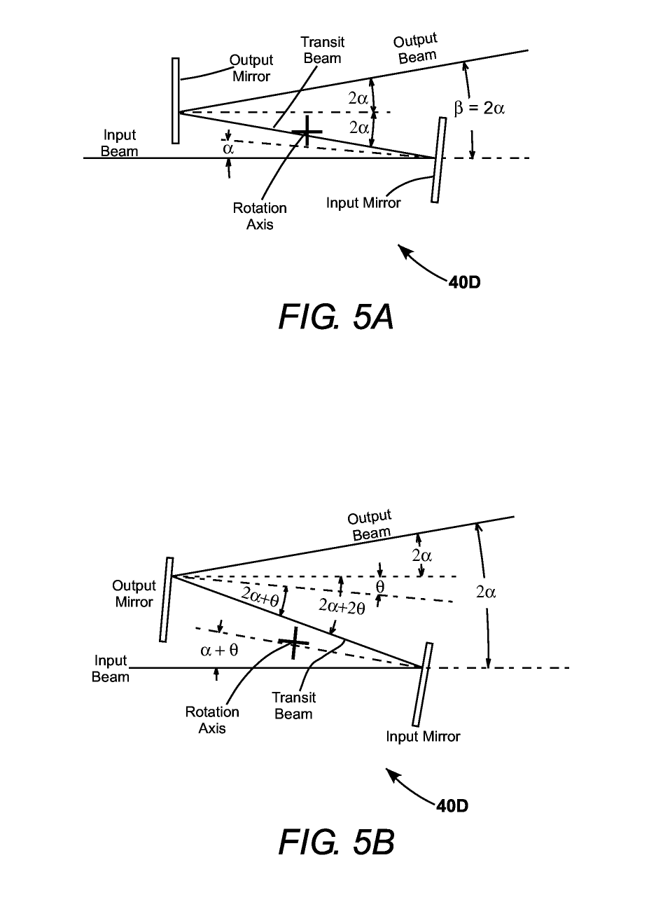

In all embodiments and applications of the inventive beam-translator described above (with the exception of embodiment 10B of FIG. 1C), the input and out mirrors are parallel to each other such that the translated output beam is always parallel to the input beam. There may be applications where it desirable to have an output beam pointed in a different direction to the input beam, for example to match a particular resonator or optical system arrangement in which the translator is used. This can be accomplished, while still having a consistent direction of the translated output beams by having the input and output mirror not parallel to each other. A description of such arrangement is set forth below with reference to FIG. 5A and FIG. 5B.

In FIG. 5A a translator 40D is depicted in an initial condition with input and output mirrors not parallel to each other and with the output mirror perpendicular to the input beam direction. Accordingly, a normal to the output mirror (indicated by a short and long dashed line) is parallel to the input-beam direction. The incidence angle of the input beam on the input mirror is an angle α which makes the angle between the input beam and the transit beam equal to 2α. This makes the incidence angle of the transit beam on the output mirror and the reflection angle from the mirror equal to 2α. As the normal to the mirror is parallel to the input beam direction then the output beam is inclined at an angle 2α to the input beam.

In FIG. 5B the translator is depicted as rotated about the rotation axis by an arbitrary angle θ from the FIG. 5A condition making the incidence angle of the input beam on the input mirror equal to α+θ. This tilts the transit beam by an angle 2θ away from the input beam direction and tilts the normal to the output mirror by angle θ towards the input beam direction, making the new angle of incidence of the transit beam on the output mirror (and the angle of reflection from the output mirror) equal to 2α+θ. a +0. As the normal has tilted toward the input beam direction by angle θ, the angle between the output beam direction and the input beam direction is still 2α as indicated in FIG. 5B.

It should be noted here that the translator arrangement of FIGS. 5A and 5B is only effective for one direction of scanner rotation because the input and output mirrors are non-parallel. If rotated in direction perpendicular to that depicted and described the output beam direction would change according to that rotation. This makes the arrangement somewhat less tolerant to bearing errors.

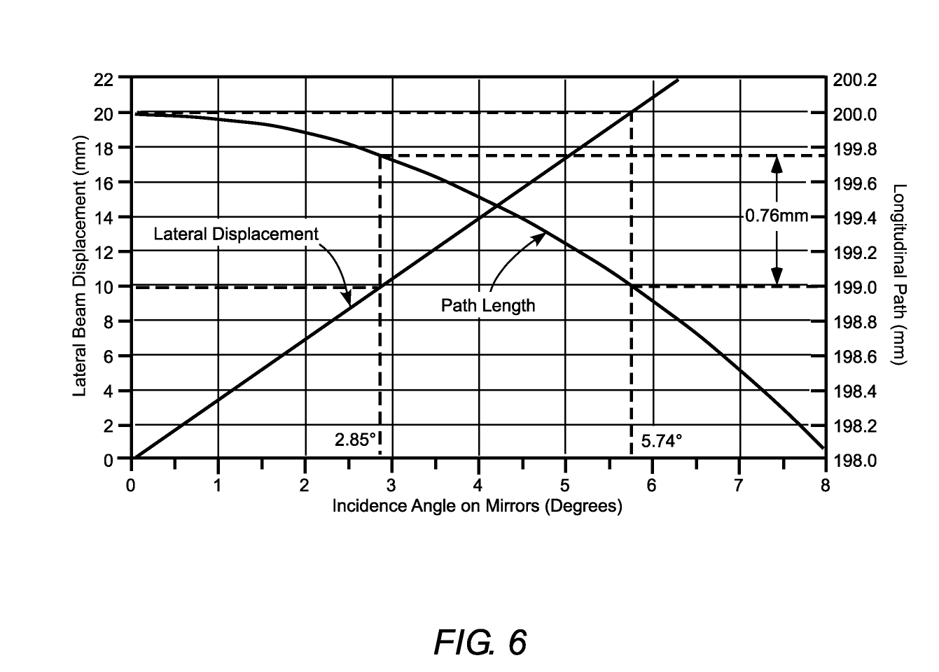

It is import to recognize that while the inventive translator in various embodiments thereof can precisely translate the output beam with very precise maintenance of the output-beam direction this is accompanied by a change in path length of a beam through the translator. In terms of applications described above, a change in path length in a mode-locked laser-resonator will change the pulse repetition frequency (PRF) of the mode-locked output pulses. In an arrangement for incrementally translating a beam over an optically nonlinear crystal, the change in path length will result in a change in position of the beam-waist (see FIG. 3B) in the optically nonlinear crystal. Fortunately the inventive translator can be configured to minimize the path-length change to keep effects thereof in tolerable limits. This is described below with reference to FIG. 6, which graphically and schematically depicts lateral translation and path-length change as a function of rotation (incidence) angle in an example of the beam translator of FIG. 1 with output beams parallel to the input beam.

The lateral displacement is measured perpendicular to the input beam path. The path length is calculated as the length L1 of the transit beam between the input and output mirrors plus a distance L2 measured parallel to the input beam direction between the point at which the output beam leaves the output mirror and an imaginary point perpendicularly above the point at which the input beam is incident on the input mirror. In the graph, a separation between the mirrors, along a common normal thereto, of 100 mm is assumed. If the included angle between the mirrors is kept acute, then as L1 increases with rotation angle, L2 will decrease, albeit less than sufficient to offset the increase. This provides a first general rule of operation. The angles of incidence on mirrors 42 and 44 should preferably be kept less than 20 degrees, and more preferably less than 10 degrees, for minimizing a path-length change.

Beyond that general rule, the graph of FIG. 6 can be used to establish a compromise between available beam-translation and corresponding path-length increase. As depicted on the graph, rotating the translator such that the incidence angle on the mirrors changes from 2.85 to 5.74, will change the lateral displacement of the output beam from about 10 mm to about 20 mm, for a net 10 mm change. This net change is accompanied by a change in path-length of 0.76 mm.

To put these quantities in perspective, the 10 mm lateral displacement change is sufficient for most applications where incremental beam translation on a SESAM is required. The 10 mm lateral displacement change is more than sufficient for most applications involving beam translation on an optically nonlinear crystal, where for example, about 5 mm or less change would be adequate. A path length increase of 0.76 mm in a mode-locked resonator having a nominal length of about 2 meters would change the output PRF from 75.000 MHz to 74.719 MHz, which would be a negligibly small change in most applications. In an optically nonlinear crystal the Rayleigh range of the beam-waist could be made long enough to minimize any efficiency change resulting from even a 0.76 mm beam-waist shift.

In summary, the present invention is described above in terms of a preferred and other embodiments. The invention is not limited, however, by the embodiments described and depicted. Rather the invention is limited only by the claims appended hereto.

What is claimed is:

1. Optical apparatus, comprising:
a laser-resonator terminated by first and second mirrors;
a gain-element within the laser-resonator;
a source of optical pump-radiation arranged to deliver optical pump-radiation to the gain-element thereby causing a beam of laser-radiation to circulate in the laser-resonator between the first and second end-mirrors along a beam-path, the beam path being normally incident on the first and second mirrors at corresponding first and second incidence points;
a plurality of beam-translation mirrors located within the laser-resonator in beam-path, the beam-translation mirrors being spaced apart in a fixed relationship with each other, with the laser-radiation beam incident on each of the beam-translation mirrors at an acute angle of incidence, the plurality of beam-translation mirrors being selectively rotatable as a group about at least a first axis, with the laser-radiation beam making an even number of reflections from the beam-translation mirrors; and
wherein the selective rotation of the plurality of beam-translation mirrors selectively changes the incidence angle of the laser-radiation beam on each of the plurality of beam-translation mirrors thereby selectively translating the second incidence point on the second end-mirror, while maintaining normal incidence of the beam path on the second end-mirror.

2. The apparatus of claim 1, wherein there are only first and second beam-translation mirrors, with reflecting faces thereof facing each other with the laser beam incident on the first and second mirrors at respectively first and second incidence angles.

3. The apparatus of claim 2, wherein the reflecting faces of the first and second beam-translation mirrors are parallel to each other, and the first and second angles of incidence are the same.

4. The apparatus of claim 3, wherein the first and second angles of incidence are less than 20 degrees.

5. The apparatus of claim 4, wherein the first and second incidence angles are less than 10 degrees.

6. The apparatus of claim 2, wherein the reflecting faces of the first and second beam-translation mirrors are not parallel to each other, and the first and second angles of incidence are different.

7. The apparatus of claim 6, wherein the first and second angles of incidence are less than 20 degrees.

8. The apparatus of claim 7, wherein the first and second angles of incidence are less than 10 degrees.

9. The apparatus of claim 2, wherein the first and second beam-translation mirrors immediately precede the second end-mirror in the beam path from the first end-mirror to the second end-mirror.

10. The apparatus of claim 2, wherein the laser-radiation beam makes one reflection from the first beam-translation mirror and one reflection from the second beam-translation mirror.

11. The apparatus of claim 2, wherein the laser-radiation beam makes two reflections from the first beam-translation mirror and two reflections from the second beam-translation mirror.

12. The apparatus of claim 1, wherein there are only first, second, and third beam-translation mirrors, with reflecting faces of the first and third beam-translation mirrors facing the reflecting face of the second beam-translation mirror.

13. The apparatus of claim 12, wherein the laser radiation beam makes one reflection from each of the first and third beam-translation mirrors and two reflections from the second beam-translation mirror.

14. The apparatus of claim 1, wherein the laser-resonator is a folded laser-resonator including at least one fold-mirror between the first and second end-mirrors.

15. The apparatus of claim 1, wherein the second end-mirror is a semiconductor saturable absorption mirror for mode-locking the laser-resonator, and the first end mirror is partially transparent for coupling laser-radiation out of the laser-resonator.

16. The apparatus of claim 1, wherein the plurality of beam-translation mirrors is selectively rotatable as a group about a second axis perpendicular to the first axis.

17. Optical apparatus, comprising:
an optically nonlinear crystal arranged to accept a beam of laser-radiation incident thereon along a beam-path and having at least a first-wavelength radiation component and convert the first-wavelength radiation component to radiation having a second wavelength different from the first wavelength;
first and second mirrors located in the beam-path, the first and second mirrors being spaced apart in a fixed relationship with each other with reflecting faces thereof facing each other and with the laser radiation beam incident on the first and second mirrors at respectively first and second acute angles of incidence, the first and second mirrors being selectively rotatable as a pair about at least a first axis perpendicular to the beam-path; and
wherein the selective rotation of the first and second mirrors selectively changes the incidence angles of the beam on the first and second mirrors thereby selectively translating the beam of laser-radiation incident on the optically nonlinear crystal.

18. The apparatus of claim 17, wherein the laser radiation beam is incident in sequence on the first mirror and the second mirror before being incident on the optically nonlinear crystal, with second-wavelength radiation exiting the crystal.

19. The apparatus of claim 18, wherein a third mirror is provided and arranged to the reflect the second wavelength radiation back to be incident in sequence on the second mirror then the first mirror, along a second-wavelength beam-path, which, following reflection from the first mirror is fixed whatever the selective rotation of the first-mirror and second-mirror pair.

20. Optical apparatus, comprising:
an optical component arranged to accept a beam of laser-radiation;
first and second mirrors, the first and second mirrors being spaced apart in a fixed relationship parallel to each other with reflecting faces thereof facing each other;
the laser-radiation beam being incident on the first mirror along a first path at a non-normal incidence thereto;
the laser-radiation beam being reflected from the first mirror to the second mirror along a second path at an angle to the first path;
the laser-radiation beam being reflected from the second mirror along a third path to a beam-spot on optical component, the third path being parallel to the first path and laterally translated therefrom; and
wherein the first and second mirrors are continuously rotatable as a pair about an axis coincident with the first path, such that the beam-spot on the optical component is continuously translated around the optical component on a circular path.

21. The apparatus of claim 20, wherein the beam-spot has a polarization orientation which—stays the same during the continuous translation thereof around the optical component on the circular path.
